(19) United States
(12) Patent Application Publication
(10) Pub. No.: US 2011/0066469 A1
(43) Pub. Date: Mar. 17, 2011

(54) METHOD AND SYSTEM FOR TRANSLATION WORKFLOW MANAGEMENT ACROSS THE INTERNET

(76) Inventor: Albert Kadosh, Prescott, AZ (US)

(21) Appl. No.: 12/559,968

(22) Filed: Sep. 15, 2009

(51) Int. Cl. G06Q 10/00; G06Q 50/00; G06Q 30/00

(52) U.S. Cl. 705/9

(57) ABSTRACT

A method and system for managing the workflow of a translation agency between an administrator, multiple customers and multiple translators allows a business to systematically and consistently provide its customers with the best quality, in the shortest time, at the lowest cost, at any given time, given its current talent pool. The method computes a weighted value for each translator based on at least one of a translation quality rating, a translation speed rating, a translation cost rating, and a dependability rating. The method generates a dynamic availability for each translator using a translator's availability profile and a result to of a number of words already assigned for translation to a translator divided by a translator's translation speed. The method assigns a customer text file to a translator for translation based on a translator's weighted value and dynamic availability and a number of words in the customer text file.

### BACKGROUND OF THE INVENTION

Many corporations and even small businesses are outsourcing work across the internet to trim overhead costs, and to increase business operating efficiencies. Others are letting their staff work from home with internet access to attract or retain talented staff. With the advent of the internet and cheap access to it, employees and contractors no longer need to be physically located in a central building nor even be physically close to each other.

However, managing in such a distributed environment creates management issues that did not exist before. Issues relating to employee productivity and top-down communication between management and staff have become problematic with managers and employees at different sites, or even in different cities, states, or countries. Also, issues relating to customer satisfaction and product delivery, inventory and cost accounting have become more complex. These problems become more acute when there are many jobs belonging to many different clients, being managed by a single administrator.

Managers of large numbers of employees often rely on weekly reports from their staff to keep on top of business progress. Also, many managers rely on meetings with their customers for business deliverables and receivables. Therefore, management may rely on the accuracy of the information reported to them from their staff and/or from their customers in the static week to week management of their business. Also, management is often resource restricted in determining how often they collect data from their staff and customers to give them an accurate picture of resources, materials and schedule.

Therefore, some managers have taken advantage of the internet to improve communication via email and even in many cases to communicate with clients solely via email. However, this does not fully utilize the power and capabilities of the internet nor does it quickly provide the necessary information a manager needs to be able to make critical management decisions. Rather, such managers are all too often consumed in reading emails, and organizing meetings rather than managing their staff according to the best information available in the production of valuable goods and services.

### SUMMARY OF THE INVENTION

In one embodiment, a method is described for managing the workflow of a translation agency between an administrator, multiple customers and multiple translators. The method includes computing a weighted value for to each translator based on at least one of a translation quality rating, a translation speed rating, a translation cost rating, and a dependability rating, where the ratings are set by the administrator. The method also includes generating a dynamic availability for each translator using a translator's availability profile and a result of a number of words already assigned for translation to a translator divided by a translator's translation speed set by the administrator. The method further includes assigning a customer text file to a translator for translation based on a translator's weighted value and dynamic availability and a number of words in the customer text file. Other embodiments of the method are also described.

Embodiments of a system are also described. In one embodiment, the system is a system for managing translation workflow in a translation agency between an administrator, multiple customers and multiple translators. The workflow management system includes a customer interface on the internet, a translator interface on the internet, and an administrator interface coupled to the customer interface and to the translator interface over the internet but accessible only by the administrator. The customer interface is configured to receive a customer text file and a customer profile from a customer. The translator interface is configured to convey a translator's daily availability and to receive a translated file from a translator based on the customer text file. The administrator interface is configured to manage a plurality of customer text files and a plurality of translated files between the customer interface and the translator interface based on a computed weighted value and a dynamic availability for each translator. Other embodiments of the system are also described.

Embodiments of a computer program product comprising a computer readable medium having computer useable program code executable to perform operations for translation workflow management are described. The operations of the computer program product include uploading a customer text file and a customer profile at a customer interface in communication with a translator interface and an administrator interface. Another operation of the computer program product includes generating a translation price for a customer at the customer interface based on a product of a number of words to be translated in the customer text file and a price per word for translation set by an administrator. Yet another operation of the computer program product includes computing a weighted value parameter for each of a plurality of translators based on point values for at least one of a quality rating, a speed rating, a cost rating and a dependability rating, where the ratings are set by the administrator. The computer program product operations further include generating a dynamic availability parameter for each translator based on a translator's availability profile and by using a product of the total number of words to be translated by a translator and a translator's daily translation capability set by the administrator. An embodiment of the operations of the computer program product includes updating the weighted value parameter when changing a point value used to compute the weighted value and updating the dynamic availability parameter when changing a translator's availability profile and when changing the translator's assigned words and daily translation capability. The operations of the computer program product further include displaying all files, all calculated numbers, all computed parameters, and all settings set by the administrator on the administrator interface in a plurality of screens, sub-screens, pull-down menus and folders. Embodiments also include assigning a customer text file to a translator for translation based on a translator's weighted value and dynamic availability and the number of words to be translated in the customer text file. An embodiment of the disclosure includes generating automatically an accounting invoice based on information from the customer text file and the customer profile and the number of words to be translated in at least one customer text file submitted for translation. The operations of the computer program product also include conveying a plurality of customer text files and a plurality of translated files over the internet between multiple customers and multiple translators via the administrator interface accessible only to the administrator. Embodiments also include downloading the translation price, the translated file, the accounting invoice, and the delivery schedule to the customer at the customer interface.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a flow chart of a method in accordance with an embodiment for translation workflow management of a workflow agency between an administrator, multiple customers and multiple translators.

FIG. 2 depicts a flow chart of a method in accordance with an embodiment for determining the assignment of a customer text file to one of many translators for translation into another language.

FIG. 3 depicts a diagram of a method in accordance with an embodiment for establishing a weighted range and selecting point values from the weighted range.

FIG. 4 depicts a diagram of a method in accordance with an embodiment for establishing a weighted range and selecting point values from the weighted range for dynamic availability.

FIG. 5 depicts a diagram of a method in accordance with an embodiment for computing a weighted value including dynamic availability as a point value and as a qualifier.

FIG. 6 depicts a diagram in accordance with an embodiment for a translation workflow management system of managing translation workflow in a translation agency between an administrator, multiple customers and multiple translators.

FIG. 7 depicts a diagram in accordance with an embodiment of an administrator's interface of the translation workflow management system.

FIG. 8 depicts a diagram in accordance with an embodiment of a translator busy chart of the translation workflow management system.

FIG. 9 depicts a diagram in accordance with an embodiment of a pull-down screen configured to allow the administrator to establish a weighted range for all translators and to select point values for each of the translators.

FIG. 10 depicts a diagram in accordance with an embodiment of a screen of accounting information in the translation workflow management system.

FIG. 11 depicts a diagram in accordance with an embodiment of a format for a management screen used by the customer, the translator and the to administrator of the translation workflow management system.

Throughout the description, similar reference numbers may be used to identify similar elements.

### DETAILED DESCRIPTION

A translation agency may employ a number of independent contractors who work for the agency on a translation job basis. The translation agency may also employ a number of payroll translators including hourly and salaried employees. The administrator of such a translation agency may also have a number of various clients having many small text files and various large text files needing translation into another language. In order to efficiently match a translator with a customer text file and translate the largest volume of customer texts possible, a translation workflow management method, system and computer program product has been developed. The disclosure herein facilitates and automates the process of assigning jobs to translators in a manner which enables a business to consistently and systematically provide its customers with the best possible quality, in the shortest period of time, at the lowest possible cost, at any given time, given its current talent pool. In the disclosed embodiments below, the translation workflow management method and system may be fully automated or semi-automated by electronic or other means. The degree of automation realized is a function of the needs of the translation agency and is by no means limited by the disclosed embodiments.

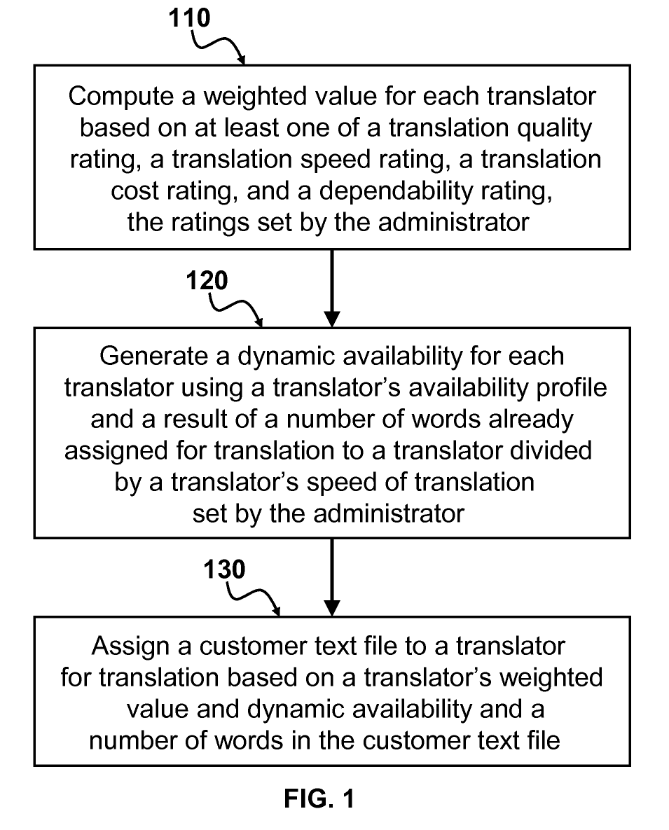

FIG. 1 depicts a flow chart of an embodiment for a method of translation workflow management of a workflow agency between an administrator, multiple customers and multiple translators. The method includes computing 110 a weighted value for each translator based on at least one of a translation quality rating, a translation speed rating, a translation cost rating, and a dependability rating. The ratings are initially set by the administrator when hiring an employee or contractor according to a translator's skills as determined by widely accepted industry standard tests and evaluation methods. The weighted value for a translator is automatically computed to include the priority or weight to the administrator places on a rating relative to the other ratings and dependability. The weighted value allows the administrator to also prioritize business objectives such as translation quality over translation speed and dependability over translation cost.

The disclosed method also includes generating 120 a dynamic availability automatically for each translator using a translator's availability profile and the result of a number of words already assigned for translation to a translator divided by a translator's translation speed set by the administrator. The translator's availability profile alone may indicate he is immediately available for work, but may not include the work the translator currently has been assigned. The automatic division of the number of words assigned to the translator by the translator's translation speed will yield a quantity of time which is added to the availability indicated by the translator's profile to automatically generate the dynamic availability.

The method of FIG. 1 further includes automatically assigning 130 a customer text file to a translator for translation based on a translator's weighted value and dynamic availability and a number of words in the customer text file. A translator having the highest weighted value and who is the soonest available may be automatically assigned a typical customer text file for translation. However, a very large customer text file may put a translator temporarily out of availability. In these cases, the method may include breaking up large customer text files into smaller pieces and assigning the smaller pieces to several translators. Therefore, the disclosed method may automatically update each translator's dynamic availability according to how many words each is assigned from the partitioned customer text file.

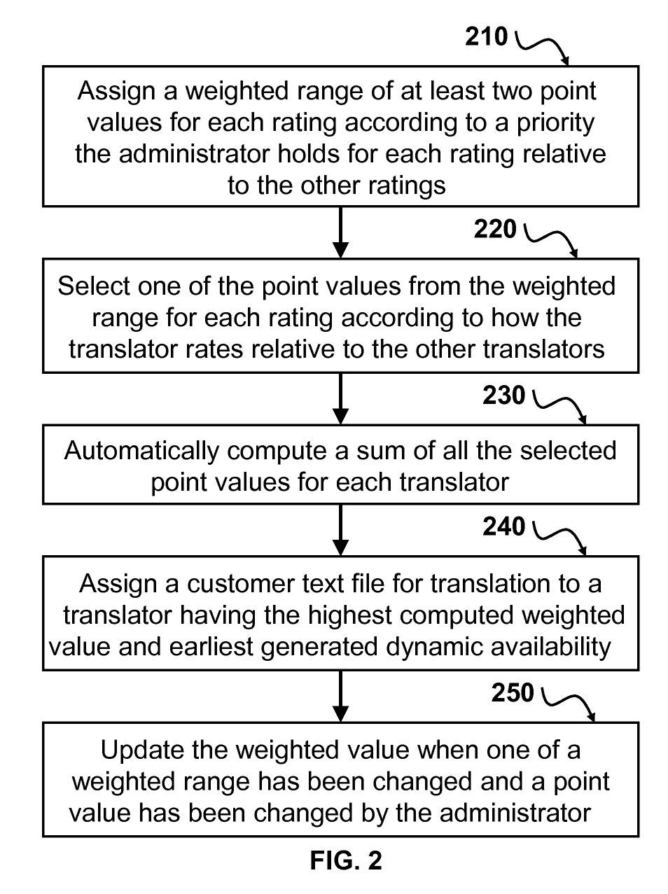

FIG. 2 depicts a flow chart of a method in accordance with an embodiment for determining the assignment of a customer text file to one of many translators for translation into another language. Therefore, the translation workflow management method of claim 1 further includes establishing 210 a weighted range of at least two point values for each rating according to a priority the administrator holds for each rating relative to the other ratings. The weighted range may be established for all translators in the agency at once. The embodiment further includes selecting 220 one of the point values from the weighted range for each rating for each translator according to how the translator rates relative to the other translators. The embodied method allows the administrator to initially select only a weighted point value from the established range and therefore assign jobs to the translation agency's translator pool according to predetermined business objectives.

The embodied method further includes automatically computing 230 the weighted value from the sum of all the selected point values for each translator and automatically assigning 240 a customer text file for translation to a translator having the highest computed weighted value and the earliest generated dynamic availability. Also updating 250 the weighted value when one of a weighted range has been changed and a point value has been changed by the administrator is included in accordance with the embodied method. This may occur when a change to the agency's translator pool has occurred with employee development or with hiring and reduction in force events.

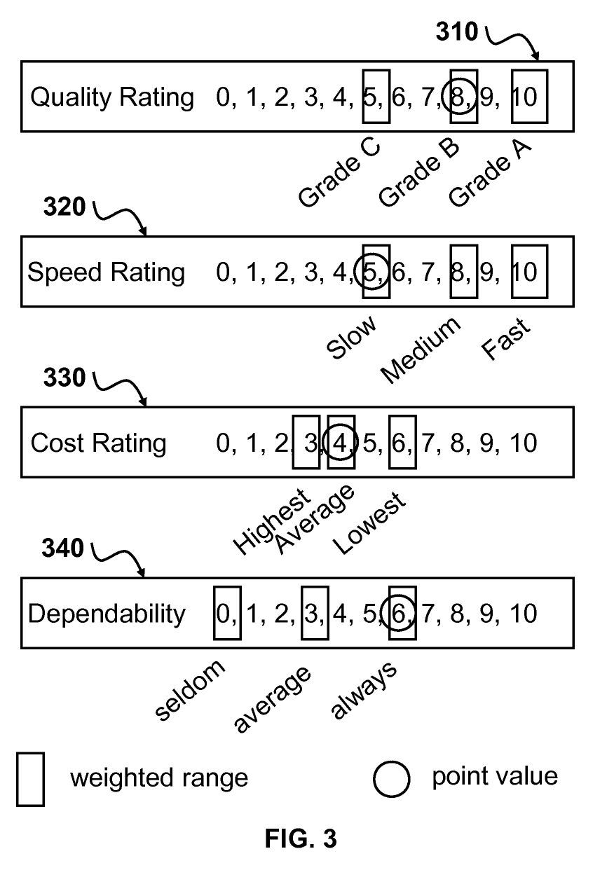

FIG. 3 depicts a diagram of an embodiment of a method for establishing a weighted range and selecting point values from the weighted range. The diagram includes the ratings: translation quality 310, translation speed 320, translation cost 330, and dependability 340. The administrator initially establishes a weighted range of three point values depicted inside squares. The administrator establishes the weighted range according to the importance a rating has to the administrator relative to the other ratings. Therefore the administrator may emphasize or prioritize a rating by establishing higher point values to select from when rating a translator. Other embodiments may include weighted ranges of as few as two point values or may include weighted ranges of as many as 3 or 4 or more. The same weighted range of point values for a rating is chosen by the administrator for all translators at once but may be changed by the administrator. It is only the selection of a particular point value, depicted by a circle, for a specific translator that is unique to the translator. The weighted range applies to all translators and is the same for all translators. Once a weighted range and specific point values have been initially chosen by the administrator, a translator's weighted value is automatically computed each time a customer text file is to be automatically assigned.

Per FIG. 3, the administrator has initially chosen a grade A quality rating to be assigned a 10 point value, a grade B quality rating to be assigned an 8 point value, and a grade C rating to be assigned a 5 point value. Only the assigned point values indicated by a square may be subsequently selected by the administrator, indicated by a circle, to be included in the automatic computation of the weighted value for each translator. The administrator subsequently selects the point value 8, depicted by a circle, corresponding to a grade B for a certain translator. In making this selection, the administrator may take into account the quality of translation the translator has performed for the administrator and also the quality of translation the translator has performed for other translation agencies. An administrator having higher priority for translation cost or dependability may establish lower point values for the A, B, and C grades relative to translation cost or dependability.

For the same translator as above, the administrator has initially chosen a ‘fast’ translation speed rating to be assigned a 10 point value, a ‘medium’ translation speed rating to be assigned an 8 point value, and a ‘slow’ translation speed rating to be assigned a 5 point value. The administrator subsequently selects the point value 5, depicted by a circle, corresponding to a ‘slow’ translation speed for the translator. In making this selection, the administrator may take into account translation speed measured from turn around time of a customer text file into another language and the size of the customer text file as measured by the number of source language words it contains. In determining the number of words a customer text file contains, automated electronic methods may be employed in an embodiment.

Continuing with FIG. 3, the administrator has initially chosen a ‘lowest’ translation cost rating to be assigned a 6 point value, an average translation cost rating to be assigned a 4 point value, and a highest translation cost rating to be assigned a 3 point value. The administrator subsequently selects the point value 4, depicted by a circle, corresponding to an average translation cost for the translator. In making this selection, the administrator may take into account the fees the translator charges to the translation agency and any overhead cost to the agency for employing the translator.

The administrator has initially chosen an always dependable rating to to be assigned a 6 point value, an average dependability rating to be assigned a 3 point value, and a seldom dependable rating to be assigned a 3 point value. The administrator subsequently selects the point value 6, depicted by a circle, corresponding to an always dependable rating for the translator. In making this selection, the administrator may take into account how often the translator delivers a translated file on schedule or according to contract.

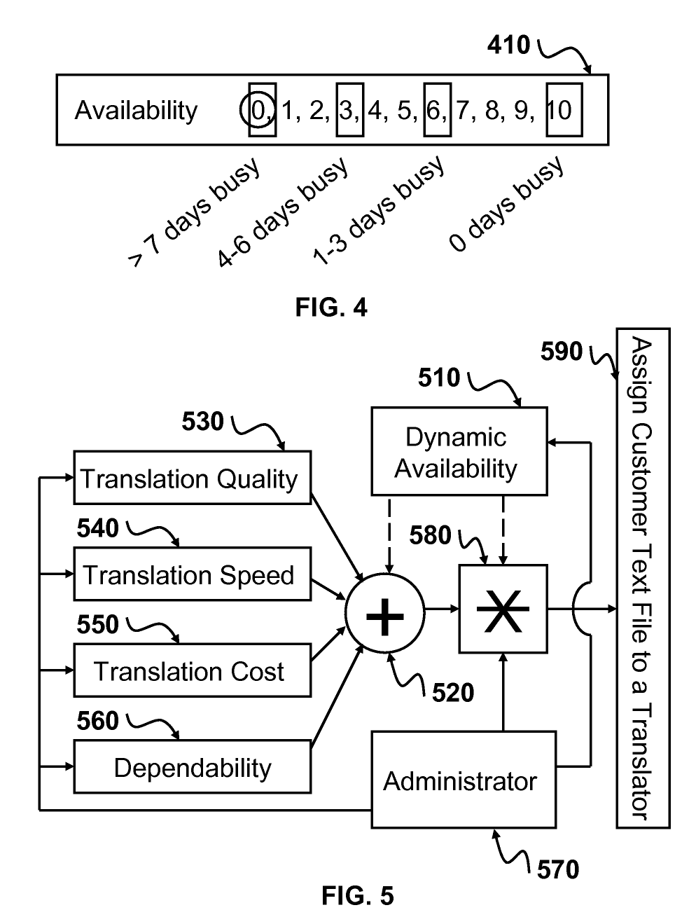

FIG. 4 depicts a diagram of an embodiment of a method for establishing a weighted range and selecting point values from the weighted range for dynamic availability. The embodied method includes initially establishing a weighted range of at least two point values for the dynamic availability 410 for all translators according to a priority the administrator holds for the dynamic availability relative to the other ratings. It also includes automatically determining one of the point values from the weighted range for the dynamic availability for each translator according to the value automatically generated for the dynamic availability. A customer text file may therefore be automatically assigned for translation to a translator having the highest computed weighted value based on the automatic sum of the selected point values for the ratings and the automatically determined point value for the dynamic availability.

A translator's dynamic availability is automatically updated when at least one of an event occurs of assigning an additional customer text file to a translator, assigning a translated file to a translator for revision, changing a translator's speed of translation, changing a translator's availability profile, removing a translator from the translation agency, and any event the administrator deems appropriate.

A translator's profile may be initially established by the translator or by the administrator. The profile may include a translator's status as a payroll or contracted employee. It may also include a daily capability and a daily availability including the translator's vacation, personal time, sick time and hours per day the translator expects to be available to translate. The translator's profile may be updated by the translator at any time and result in an automatic regeneration of a translator's dynamic availability.

The administrator has initially chosen 0 days busy to be assigned a 10 point value, 1-3 days busy to be assigned a 6 point value, 4-6 days busy to be to assigned a 3 point value and over 7 days busy to be assigned a 0 point value. The generated dynamic availability therefore automatically determines the point value 0, depicted by a circle, corresponding to a translator being over 7 days busy. The administrator may bypass the automatic determination of the dynamic availability point value when necessary to take into account other factors such as unscheduled training and mentoring time for junior and senior translators respectively.

FIG. 5 depicts an embodiment of a method of computing a weighted value including dynamic availability as a point value and as a qualifier. Dynamic availability 510, may be included in a first mode by the first dashed arrow into the sum computation 520 with the ratings translation quality 530, translation speed 540, translation cost 550, and dependability 560. The first mode is typically used for assigning independent contractors paid by the job. The first mode adds dynamic availability with the 3 ratings and dependabilty in making the assignment. Dynamic availability may separately be included by the second dashed arrow in a second mode as a qualifying input to the multiplier product 580 used to assign a customer text file to a translator 590. The second mode is typically used to assign a customer text file to hourly or salaried paid employees on payroll. Therefore, the administrator may input a translator's status as a contractor or a payroll employee in the translator's profile. Accordingly, a customer text file may be automatically assigned to a translator through the first or second modes based on the translator's status as a payroll or contracted employee.

The administrator may have input into or set the dynamic availability, the translation quality, the translation speed, the translation cost and dependability. The administrator may also infrequently override the final product 580 of the weighted value indicated by the arrow input from the administrator 570 into the final product 580. An administrator employing hourly full-time payroll translators may choose to include availability as a qualifying multiplier to assigning translation jobs to minimize paying an employee who does not have any files to translate. In other words, when customer files are available for translation they are assigned to the translator with the highest weighted value who is qualified by his or her availability. However, where independent contractors are employed on a per job basis, availability may be included in computing the weighted value and assignment of a customer text file completely decided on the translator's to weighted value alone.

In the second mode, for example, a ‘translator 1’ who scores a 23 in summation block 520 (see FIG. 3 circled values), but is not available for over 7 days will get a multiplier of zero and a total score of 0 (23*0=0) and therefore will not get assigned a new customer text file until he starts to become available. Another translator, say ‘translator 2’, who scores a 13 in block 520 (all lowest possible point values in FIG. 3) but is 0 days busy, will get a qualifying multiplier of 10 and therefore 13*10=130 points total score and get assigned the customer text file job.

On the other hand, translator 2 who is always available but scores very low in the 3 ratings and dependability may scarcely get a job in the first mode because other translators rating higher but who are very busy may still outscore him. For example, in the first mode, translator 1 scores a 23 with 0 points for availability and without a 0 multiplier totals 23 points. Translator 2 scores his 13 points plus 10 for his 0 days busy, for a total of 23. In this case there is a tie, but should the administrator have established a 9 point value for 0 days busy, translator 2 would have lost out on the assignment. A tie between a payroll employee and a contracted employee is automatically decided in favor of the payroll employee. In the event there is a tie between a contracted employee and another contracted employee, the administrator may decide the assignment.

An embodiment of the disclosed method includes non-routinely assigning a customer text file to a translator for translation based on any factor chosen by the administrator. An administrator may choose to base assignment on the customer rather than on the translator where a preferred customer may get a preferred translator. Therefore, FIG. 5 includes a bypass option, also known above as the override option, whereby the administrator may qualify a translator on any factor of the administrator's choosing and override the computed final product of the weighted value and dynamic availability altogether. Also, the administrator may change an assignment of a customer text file from an assigned translator to another translator based on any factor chosen by the administrator, either arbitrary or customer or client related.

An embodiment of the disclosed translation workflow management method further includes automatically conveying an assigned customer text file to a respective translator via a translator interface coupled to an administrator interface and to a customer interface. The interfaces are typically electronic but are not limited to electronic means. The customer text file is received at the customer interface by an upload of a customer text file submitted for translation by the respective customer. Likewise, a file translated from a customer text file by a translator is received at the translator interface by an upload of a submitted translated file from a respective translator. Additionally, an assigned customer text file and a respective translated file may be conveyed to a reviser via a reviser interface coupled to the administrator interface when a translator's translation quality rating falls below a set threshold. Similarly, a revised translated file may be received from the reviser at the reviser interface by an upload of a submitted revised file. The revised translated file may therefore be automatically conveyed to the administrator via the administrator interface.

There exists an embodiment of the translation workflow management method disclosed for managing multiple customer text files and multiple translated files between the customers and the translators over the internet in batch mode. Batch mode also facilitates auto-deleting a customer text file and a translated file older than an amount of time set by the administrator. Also, batch mode allows auto-archiving a customer text file and a translated file not yet aged to the amount of time set by the administrator.

Another embodiment of the translation workflow management method includes generating a translation price for the customer at the customer interface based on the product of the number of words to be translated in the customer text file and a price per word for translation set by the administrator. This embodiment allows the customer to quickly obtain an estimate of the cost he or she can expect to expense for the translation of his or her document prior to his or her submission of the document and payment to the translation agency.

Embodiments of the translation workflow management method further comprise automatically pre-pending a unique job number to a customer text file uploaded at a customer interface and linking the job number to a customer profile also uploaded at the customer interface. The unique job number facilitates automatically searching at least one of a plurality of customer text files, translated files, and revised translated files based on the pre-pended job number. Such to searches may be used to determine an associated translator, an associated reviser, and an associated customer and to determine any other arbitrary information as defined by the administrator.

The pre-pended job number also allows automatically generating an accounting information file based on the customer text file and the customer profile. Additionally, an embodiment may automatically generate a delivery schedule based on the assigned translator's dynamic availability and the number of words in the customer text file. The accounting file is conveyed to the customer via a download by the customer at the customer interface. Likewise, the delivery schedule is conveyed with the customer text file to an assigned translator via a download by the translator at the translator interface.

In accordance with an embodiment, the translation workflow management method further includes generating an automatic email notification to the administrator when at least one event occurs of a customer uploading a text file at the customer interface and a translator uploading a translated file at the translator interface. An automatic email notification is also sent to the customer when at least one event occurs of an uploading of a translated file from the customer interface and the automatic generation of a delivery schedule. Likewise, an automatic email notification is sent to a translator when at least one event occurs of an automatic assignment of a customer text file to the translator based on the weighted value and the dynamic availability of the translator and the administrator making an infrequent assignment of a customer text file to a translator.

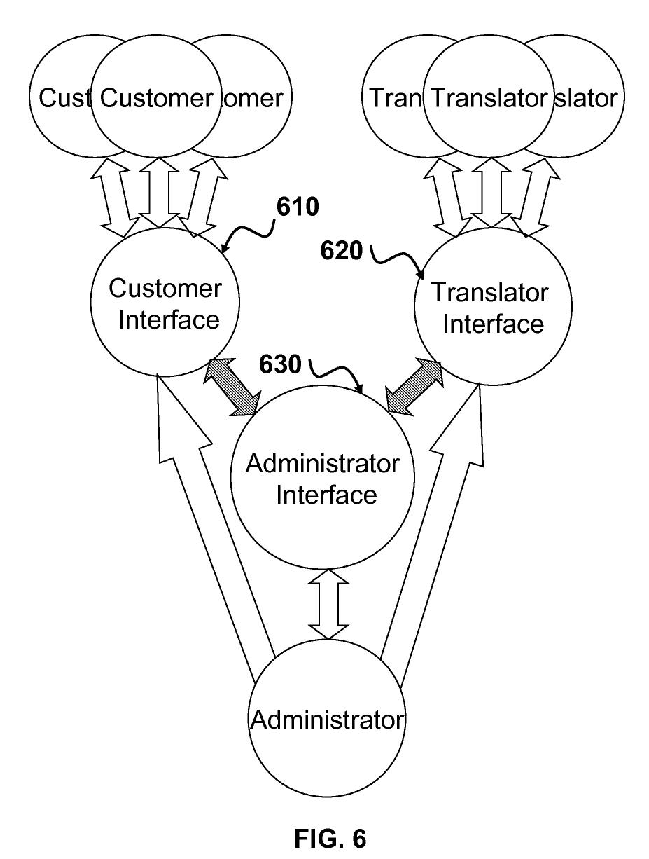

FIG. 6 depicts a diagram in accordance with an embodiment for a translation workflow management system of managing translation workflow in a translation agency between an administrator, multiple customers and multiple translators. The workflow management system includes a customer interface 610, a translator interface 620, and an administrator interface 630 connected to both the customer interface and the translator interface. The customer interface on the internet or on a network is configured to receive a customer text file and a customer profile from a customer. The solid bidirectional arrows of FIG. 6 are indicative of connections across the internet or across a local or wide area network. Other customer interfaces may also be opened according to the number of customers accessing the translation agency's website. The translator interface 620 is configured to receive a translator's daily availability and to receive a translated file from a translator based on the customer text file. The administrator interface 630 is accessible only by the administrator. The administrator interface is configured to manage the automatic assignment of a plurality of customer text files and a plurality of translated files between the customer interface and the translator interface based on a computed weighted value and a dynamic availability for each translator as described above. Also, the administrator may directly access the administrator interface or the customer and translator interfaces as depicted in FIG. 6.

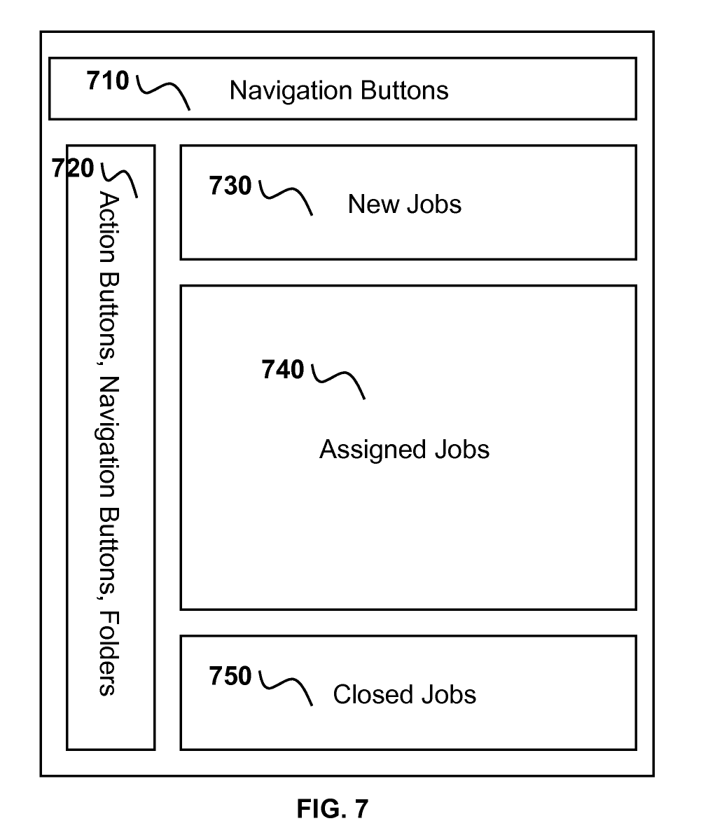

FIG. 7 depicts a diagram in accordance with an embodiment of an administrator's interface of the translation workflow management system. The administrator's interface may include internet navigation buttons 710, action buttons and folders and further navigation buttons 720, a new jobs sub-screen 730, an assigned jobs sub-screen 740, and a closed jobs sub-screen 750. The internet navigation buttons may navigate and link the administrator across the internet or a local area network to a manage jobs screen, a manage translators screen, a manage customers screen, a reports screen, a settings screen, and a user manager screen. The format of the different screens and the respective functions are discussed in detail below.

Though FIG. 7 depicts an embodiment of the administrator interface, other embodiments further include a new jobs folder and screen, an assigned jobs folder and screen, and a closed jobs folder and screen for at least one of the customer interface, the translator interface, the reviser interface and the administrator interface. Also other embodiments may include an upload and a download screen for at least one of the customer interface, the translator interface, the reviser interface and the administrator interface. The upload and download screens are configured to convey at least one of a customer text file, a translated file, and a revised translated file to another interface.

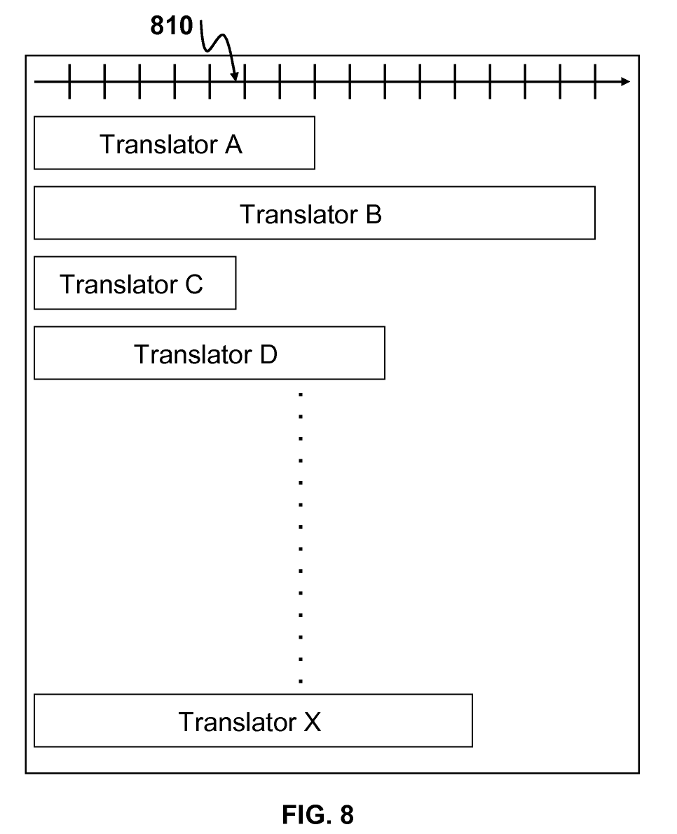

FIG. 8 depicts a diagram in accordance with an embodiment of a translator busy chart of the translation workflow management system. The translator busy chart is accessible from the manage translators screen. The to translator busy chart displays a dynamic availability of multiple translators A, B, C, D, and as many as X translators on a day to day basis and includes a scale 810. The scale 810 may demarcate hours, days, or any other period of time as determined by the administrator. A translator's dynamic availability may include translator vacation, translator sick time and hours per day each translator expects to be available to translate and the employee's status as a payroll or contracted employee.

A translator weighted value chart is also accessible from the manage translator's screen. The weighted value chart displays each point value and the sum of point values for at least two of a quality rating, a speed rating, a cost rating and dependability for multiple translators. It may also display a translator's dynamic availability. The translator weighted value chart is similar in appearance to the translator busy chart in that it includes a bar of length indicative of a translator's weighted value and associated point values for each rating. Also, a scale similar to the scale 810 numerically demarcates the weighted value and associated point values.

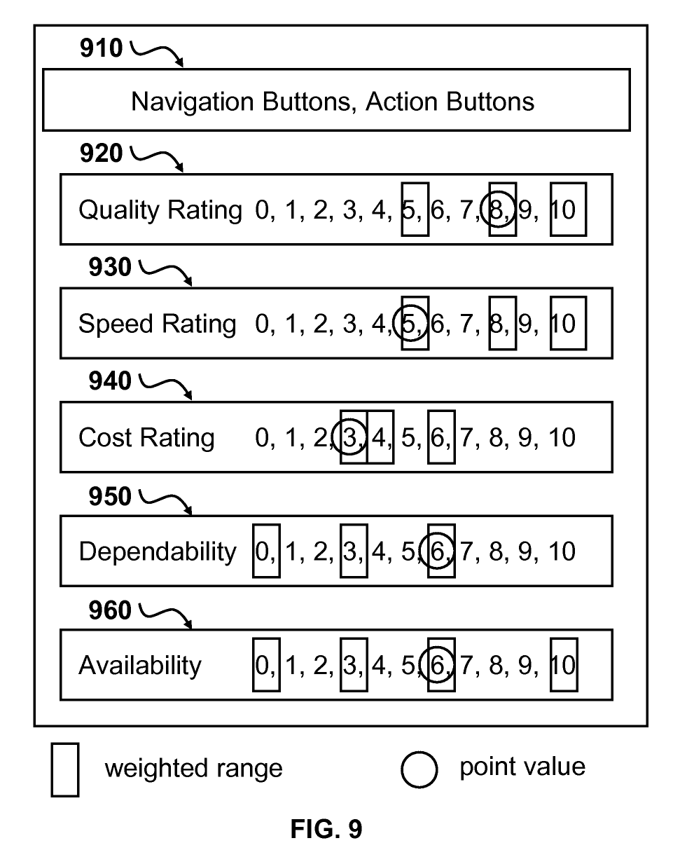

FIG. 9 depicts a diagram in accordance with an embodiment of a pull-down screen configured to allow the administrator to establish a weighted range for all translators and to select point values for each of the translators. The pull-down screen includes internet navigation and action buttons 910, the translation quality rating 920, translation speed rating 930, the translation cost rating 940, dependability 950, and dynamic availability 960. The pull-down screen is accessible from the settings navigation button of the administrator's interface. The administrator establishes a weighted range of two or more point values depicted inside squares. The administrator establishes the weighted range according to the importance a rating or factor has to the administrator relative to the other ratings or factors. Therefore the administrator may emphasize or deemphasize a rating by establishing higher point values or lower point values respectively to select from when rating a translator. The same weighted range of point values for a rating is chosen by the administrator for all translators at once.

The administrator selects a particular point value, depicted by a circle, for each specific translator one at a time. However, only the assigned point values indicated by a square may be selected by the administrator to be included in the computation of the weighted value for each translator. The administrator may change the selected point value for a translator at any time through the pull-down screen. In making the point value selection, the administrator may take into account the quality of translation the translator has performed for the administrator and also the quality of translation the translator has performed for other translation agencies. An administrator having higher priority for translation cost or dependability may establish higher point values for cost and dependability relative to translation quality.

Returning to FIG. 9, in making the selection for translation speed, the administrator may take into account translation speed measured from turn-around time of a customer text file into another language and the size of the customer text file as measured by the number of English words it contains. In determining the number of words a customer text file contains, manual or automated and electronic methods may be employed in an embodiment. When making the selection for translation cost, the administrator may take into account the fees the translator charges to the translation agency and any overhead cost to the agency for employing the translator. In making the dependability selection, the administrator may take into account how often the translator delivers a translated file on schedule or according to contract.

The availability selection may be done automatically by the system and it may be done by the administrator on a non-routine basis. The system generates a dynamic availability for each translator using a translator's availability profile and the result of a number of words already assigned for translation to a translator divided by a translator's translation speed initially set by the administrator. The translator's availability profile includes factors keeping the translator from being immediately available for work such as vacation, sick time, personal time and training and mentoring time but may not include the work the translator currently has been assigned. Therefore, the system performs a calculation of the number of words assigned to the translator divided by the translator's translation speed. The result is a quantity of time which is added to the availability indicated by the translator's profile to generate the dynamic availability.

An embodiment of the disclosed system also includes a time zone to converter configured to automatically convert a time stamp for all uploaded customer text files to the local time of the administrator and to convert a time stamp for all uploaded translated files to the local time of the administrator. The time zone converter automatically facilitates tracking files from submission time to completion time. The administrator may access the time zone converter through the settings navigation button on the administrator interface.

The settings navigation button also links the administrator to a sub-screens comprising a business message from the administrator to all customers and a legal terms and conditions click through or click wrap agreement to all customers, a message to all translators and a legal terms and conditions click through agreement to all translators. Therefore, independent contractors may contract with the administrator and the translation agency through their click through of the terms of the agreement thus displayed. Also, non-disclosure and privacy terms click wrap agreements may be included to protect the administrator's customers.

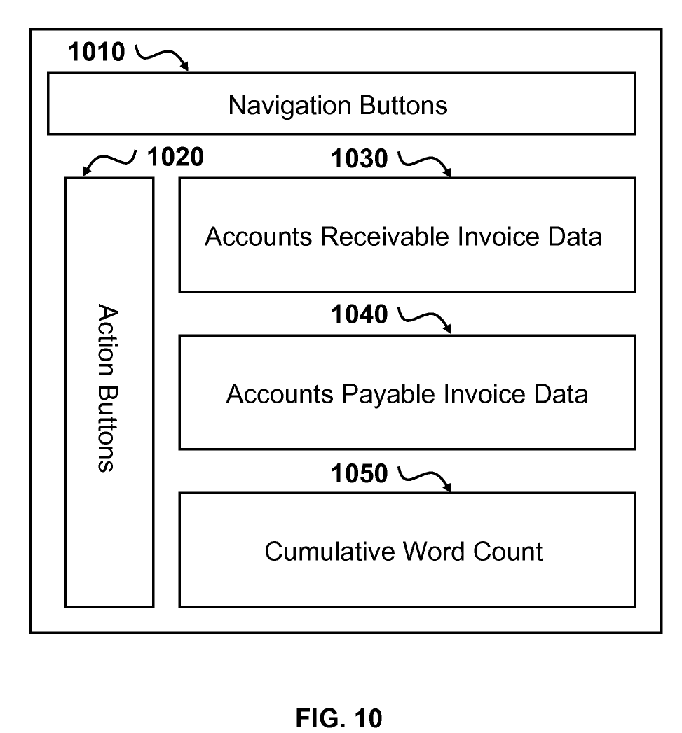

FIG. 10 depicts a diagram in accordance with an embodiment of a screen of accounting information in the translation workflow management system. FIG. 10 includes internet navigation buttons 1010, action buttons 1020 including buttons linked to an accounts receivable folder and buttons linked to an accounts payable folder, an accounts receivable invoice data sub-screen 1030, an accounts payable invoice data sub-screen 1040, and a cumulative word count utility 1050 for automatically computing a cumulative number of words translated for a customer. The accounts receivable invoice data includes invoices automatically generated for multiple customers and the accounts payable invoice data includes invoices automatically generated for multiple translators. The accounting information sub-screens are accessible from the reports navigation button on the administrator's interface. Accounting sub-screens are automatically populated with customer, translator, and file information from the translation workflow management system. Invoices are automatically generated by the translation workflow management system from the accounting information generated therein.

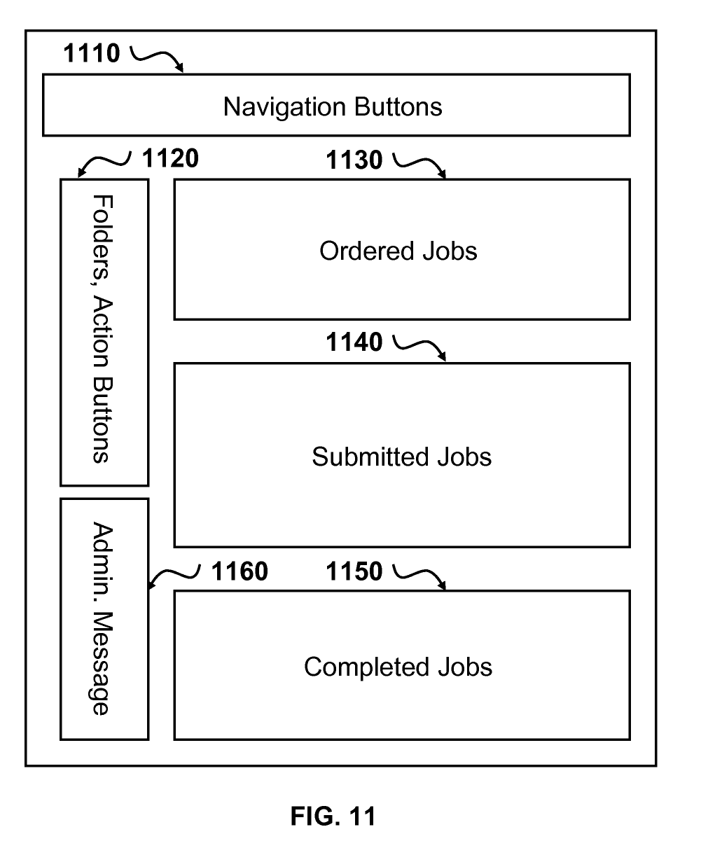

FIG. 11 depicts a diagram in accordance with an embodiment of a format for a management screen used by the customer, the translator and the administrator of the translation workflow management system. The screen to includes internet navigation and action buttons 1110, folders and action buttons 1120, an ordered jobs sub-screen 1130, a submitted jobs sub-screen 1140, a completed jobs sub-screen 1150, and an administrative message sub-screen 1160. Customers upload their documents to be translated at the ordered jobs sub-screen together with other pertinent information about the job. A customer may upload up to 5 text files, also known as documents, at one time. Documents submitted by the customer show up on the submitted jobs sub-screen. In the same way, completed jobs are displayed when clicking on the submitted jobs button. At any time, the administrator may change an administrative message which appears the same for all customers and the same for all translators.

Continuing with FIG. 11, the administrator selects the completed jobs to be delivered or conveyed to clients by checking the corresponding boxes in the completed jobs sub-screen and then clicks on a ‘move to customer’ action button. Each job is then automatically sent to the folder belonging to the client who originally submitted the job, and they are automatically notified by e-mail that their transaction is ready for download. Jobs already delivered to clients are indicated by a green check-mark circle icon next to each.

The translated version of a document is indicated by a special note automatically appended to the document name, for example: “—Spanish.” This is an automatic process performed instantly by the system when translators upload their translations. Customer files are stored on the translation agency web server for a period of time for the customer's convenience, so they may come back and download their translations again anytime.

In an embodiment, the assigned jobs screen of the customer interface, the translator interface, the reviser interface and the administrator interface further comprises at least one sub-screen including a customer name, a job file name automatically pre-pended with a unique job number, a number of total words in a text file, a purchase order number, a translator assigned to work on a text file, and an estimated delivery date.

An embodiment of the disclosure includes a computer program product comprising a computer readable medium having computer useable program code executable to perform operations for translation workflow to management of a translation agency. The operations of the computer program product include uploading a customer text file and a customer profile at a customer interface in communication with a translator interface and an administrator interface. When a customer uploads a new document to the web site, the administrator selects it by checking the appropriate box, and then clicks on an ‘assign translator’ button to send the job to a translator, thereby assigning the job.

The system then displays the newly assigned job with the customer name, customer purchase order number, the number of words in the job, the translator assigned to the job, and the estimated delivery date. The estimated delivery date is calculated automatically based on the current work load of the translator, the daily capacity of that translator, and the number of words in the newly assigned document. The estimated delivery date is then e-mailed to the customer automatically by the system.

The system notifies the translator automatically, telling them that they have a new assignment, and requests that the translator “acknowledge and accept” the job. On the same screen, the system also indicates to the administrator whether or not this has been done by displaying the appropriate symbol indicating the translator acknowledgement status for each job. After the translator has translated a document, he or she may upload up to five documents to the system at one time. The translator may then view all his or her completed jobs.

Another operation of the computer program product includes generating a translation price for a customer at the customer interface based on a product of a number of words to be translated in the customer text file and a price per word for translation initially set by an administrator. Yet another operation of the computer program product includes computing a weighted value parameter for each of a plurality of translators based on point values for at least one of a quality rating, a speed rating, a cost rating and a dependability rating. Each of the ratings is set by the administrator. The computer program product operations further include automatically generating a dynamic availability parameter for each translator based on a translator's availability profile and by using a quotient of the total number of words to be translated by a translator divided by a translator's daily translation capability initially set by the administrator.

An embodiment of the operations of the computer program product includes updating the weighted value parameter when changing a point value used to compute the weighted value. Also the dynamic availability parameter is updated by the operation of the computer program when changing a translator's availability profile and when changing the translator's assigned words and daily translation capability.

The operations of the computer program product further include displaying all files, all calculated numbers, all computed parameters, and all settings set by the administrator on the administrator interface in a plurality of screens, sub-screens, pull-down menus and folders. The administrator may then manually select a translator to assign the job to from a pull down menu, while simultaneously viewing a “Translator Busy Chart” which graphically displays how busy each translator is, given the currently assigned work load. The administrator may also, at the same time, send a brief note or comment to the translator regarding the job being assigned. However, customer text files are typically and routinely assigned to translators based on a translator's weighted value and dynamic availability and the number of words to be translated in the customer text file.

When the translator completes the assigned job and uploads the translated document, the job is either automatically delivered to the client, or transferred to a reviser for a final revision and editing prior to delivery to the client based on a translator's weighted value relative to a revised threshold value initially set by the administrator for all translators.

In an embodiment of the disclosure, the translator has the option to select the job, and “Accept & Initiate” the work. Only after clicking an ‘accept & initiate’ button placed adjacent the ‘new jobs’ sub-screen (see format of FIG. 7), indicating his agreement with the conditions summarized below, does the document become available for download to the translator. “By clicking on the ‘accept & initiate’ button, you indicate your acceptance of this translation job, your agreement with the condition of non-circumvention, and the condition to maintain all of the information contained in the document(s) being translated in the strictest confidence.” The foregoing translator conditions are also modifiable to by the administrator at any time. After indicating his acceptance of the conditions, the new document becomes available for download to the translator. A new job which has not yet been downloaded is marked with a ‘new’ symbol for easy identification.

The operations of the computer program product also include automatically generating the data necessary to create an accounting invoice based on information from the customer text file and the customer profile and the number of words to be translated in at least one customer text file submitted for translation. After the job has been delivered to the client, it appears in the reports section where the system generates the data necessary to create an invoice, allowing the administrator to export it to a file which is compatible with industry standard accounting software.

When a translation job is completed and finally delivered to the customer, the translation workflow management system, generates an invoice for the particular job or jobs performed indicating the customer name, the purchase order number, the name of the document(s) being billed, the number of words for each, and the total cost. This is all done automatically, eliminating the need for manual data input to generate invoices for jobs performed.

Also, conveying a plurality of customer text files and a plurality of translated files over the internet between multiple customers and multiple translators via the administrator interface is included in an embodiment. The administrator interface is accessible only to the administrator. The translation price, the translated file, the accounting invoice, and the delivery schedule are also downloaded to the customer at the customer interface in an embodiment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A translation workflow management method for managing the workflow of a translation agency between an administrator, multiple customers and multiple translators, the method comprising:
computing a weighted value for each translator based on at least one of a translation quality rating, a translation speed rating, a translation cost rating, and a dependability rating, the ratings set by the administrator;
generating a dynamic availability for each translator using a translator's availability profile and a result of a number of words already assigned for to translation to a translator divided by a translator's translation speed set by the administrator; and
assigning a customer text file to a translator for translation based on a translator's weighted value and dynamic availability and a number of words in the customer text file.

2. The translation workflow management method of claim 1, further comprising:
establishing a weighted range of at least two point values for each rating according to a priority the administrator holds for each rating relative to the other ratings;
selecting one of the point values from the weighted range for each rating for each translator according to how the translator rates relative to the other translators;
automatically computing the weighted value from a sum of all the selected point values for each translator;
assigning a customer text file for translation to a translator having the highest computed weighted value and the earliest generated dynamic availability; and
updating the weighted value when one of a weighted range has been changed and a point value has been changed by the administrator.

3. The translation workflow management method of claim 2, further comprising:
establishing a weighted range of at least two point values for the dynamic availability according to a priority the administrator holds for the dynamic availability relative to the other ratings;
determining one of the point values from the weighted range for the dynamic availability for each translator based on the generated dynamic availability;
assigning a customer text file for translation to a contracted translator to having a highest computed weighted value in a first mode based on the sum of the selected point values and the determined dynamic availability; and
assigning a customer text file for translation to a payroll employee having the highest computed weighted value in a second mode based on the sum of the selected point values and a product of the sum and the determined dynamic availability.

4. The translation workflow management method of claim 1, further comprising:
updating a translator's dynamic availability when at least one of an event occurs of assigning an additional customer text file to a translator, assigning a translated file to a translator for revision, changing a translator's speed of translation, changing a translator's availability profile, removing a translator from the translation agency, and any event the administrator deems appropriate; and
establishing a translator's profile comprising a daily capability and a daily availability including the translator vacation, translator personal time, translator sick time and hours per day the translator expects to be available to translate and the translator's status as a payroll or contracted employee.

5. The translation workflow management method of claim 1, further comprising:
assigning a customer text file to a translator for non-routine translation based on any factor chosen by the administrator; and
changing an assignment of a customer text file from an assigned translator to another translator based on any factor chosen by the administrator.

6. The translation workflow management method of claim 1, further comprising:
conveying an assigned customer text file received at a customer interface to a respective translator via a translator interface coupled to an administrator interface and to the customer interface;
receiving a translated file from a respective translator based on the assigned customer text file;
conveying the assigned customer text file and a respective translated file to a reviser via a reviser interface coupled to the administrator interface when a translator's quality rating is below a nominal threshold set by the administrator;
receiving a revised translated file from the reviser at the reviser interface; and
conveying the revised translated file to the administrator via the administrator interface.

7. The translation workflow management method of claim 1, further comprising:
managing a plurality of customer text files and a plurality of translated files between the customers and the translators over the internet in batch mode;
auto-deleting a customer text file and a translated file older than an amount of time set by the administrator; and
auto-archiving a customer text file and a translated file not yet aged to the amount of time set by the administrator.

8. The translation workflow management method of claim 6, further comprising generating a translation price for the customer at the customer interface based on the product of the number of words to be translated in the customer text file and a price per word for translation set by the administrator.

9. The translation workflow management method of claim 6, further comprising:
pre-pending automatically a unique job number to a customer text file uploaded at a customer interface and linking the job number to a customer profile also uploaded at the customer interface;
breaking up a large customer text file into a plurality of smaller sub-files for assignment to multiple translators while maintaining the same pre-pended unique job number on each sub-file; and
searching automatically at least one of a plurality of customer text files, to translated files, and revised translated files based on the pre-pended job number to determine an associated translator, an associated reviser, and an associated customer and to determine any other arbitrary information as defined by the administrator.

10. The translation workflow management method of claim 9, further comprising:
generating an accounting information file based on the customer text file and the customer profile and generating a delivery schedule based on the assigned translator's dynamic availability and the number of words in the customer text file; and
conveying the accounting file to the customer via a download by the customer at the customer interface and conveying the delivery schedule with the customer text file to an assigned translator via a download by the translator at the translator interface.

11. The translation workflow management method of claim 10, further comprising:
generating an automatic email notification to the administrator when at least one event occurs of a customer uploading a text file at the customer interface and a translator uploading a translated file at the translator interface;
generating an automatic email notification to the customer when at least one event occurs of an uploading of a translated file from the customer interface and an automatic generation of a delivery schedule; and
generating automatic email notification to a translator when assigning a customer text file to the translator based on the weighted value and the dynamic availability of the translator.

12. A translation workflow management system for managing translation workflow in a translation agency between an administrator, multiple customers and multiple translators, the workflow management system comprising:
a customer interface on the internet, the customer interface configured to receive a customer text file and a customer profile from a customer;
a translator interface on the internet, the translator interface configured to convey a translator's daily availability and to receive a translated file from a translator based on the customer text file; and
an administrator interface coupled to the customer interface and to the translator interface over the internet but accessible only by the administrator, the administrator interface configured to manage a plurality of customer text files and a plurality of translated files between the customer interface and the translator interface based on a computed weighted value and a dynamic availability for each translator.

13. The translation workflow management system of claim 12, further comprising a reviser interface, the reviser interface coupled to the administrator interface, the reviser interface configured to give the reviser access to a translated file when a translator's quality rating is below a nominal threshold set by the administrator and to convey a revised translated file to the administrator interface.

14. The translation workflow management system of claim 12, wherein the administrator interface further comprises at least one of a plurality of internet navigation buttons linked to a manage jobs screen, a manage translators screen, a manage customers screen, a reports screen, a settings screen, and a user manager screen.

15. The translation workflow management system of claim 13, further comprising:
a new jobs folder and screen, an assigned jobs folder and screen, and a closed jobs folder and screen for at least one of the customer interface, the translator interface, the reviser interface and the administrator interface; and
an upload and a download screen for at least one of the customer interface, the translator interface, the reviser interface and the administrator interface, the upload and download screens configured to convey at least one of a customer text file, a translated file, and a revised translated file to another interface.

16. The translation workflow management system of claim 14, wherein the manage translators screen further comprises:
a translator busy chart configured to display a dynamic availability of multiple translators on a day to day basis, the dynamic availability including translator vacation, translator sick time and hours per day each translator expects to be available to translate; and
a translator weighted value chart configured to display each point value and the sum of point values for at least two of a quality rating, a speed rating and a cost rating for multiple translators.

17. The translation workflow management system of claim 14, wherein the settings screen further comprises:
a pull-down screen, the pull-down screen configured to allow the administrator to set a point value for at least one of a quality rating, a speed rating, and a cost rating for each translator;
a time zone converter configured to automatically convert a time stamp for all uploaded customer text files to the local time of the administrator and to convert a time stamp for all translated files to the local time of the administrator; and
at least one of a plurality of sub-screens comprising a business message to all customers and a legal terms and conditions click through agreement to all customers, a message to all translators and a legal terms and conditions click through agreement to all translators.

18. The translation workflow management system of claim 14, wherein the administrator interface is further configured to automatically generate and manage an accounts receivable folder for multiple customers and an accounts payable folder for multiple translators from the reports screen.

19. The translation workflow management system of claim 15, wherein the assigned jobs screen further comprises at least one of a plurality of sub-screens comprising a customer name, a job file name automatically pre-pended with a unique job number, a number of total words in a text file, a purchase order number, a translator assigned to work on a text file, and an estimated delivery date.

20. A computer program product comprising a computer readable medium having computer useable program code executable to perform operations for translation workflow management, the operations of the computer program product comprising:
uploading a customer text file and a customer profile at a customer interface in communication with a translator interface and an administrator interface;
generating a translation price for a customer at the customer interface based on a product of a number of words to be translated in the customer text file and a price per word for translation set by an administrator;
computing a weighted value parameter for each of a plurality of translators based on a point value for at least one of a quality rating, a speed rating, a cost rating and a dependability rating, the ratings set by the administrator;
generating a dynamic availability parameter for each translator based on a translator's availability profile and by using a product of a total number of words to be translated by a translator and a translator's daily translation capability set by the administrator;
updating the weighted value parameter when changing a point value used to compute the weighted value and updating the dynamic availability parameter when changing a translator's availability profile and when changing a translator's assigned words and daily translation capability;
displaying a plurality of files, calculated numbers, computed parameters, and settings set by the administrator on the administrator interface in a plurality of screens, sub-screens, pull-down menus and folders;
assigning a customer text file to a translator for translation based on the translator's weighted value and dynamic availability and the number of words to be translated in the customer text file;
generating automatically an accounting invoice based on information from the customer text file and the customer profile and the number of words to be translated in at least one customer text file submitted for translation;
conveying a plurality of customer text files and a plurality of translated files over the internet between multiple customers and multiple translators via the administrator interface accessible only to the administrator; and
downloading the translation price, a translated file, the accounting invoice, and a delivery schedule to the customer at the customer interface.
